(19) United States
(12) Patent Application Publication
(10) Pub. No.: US 2020/0359812 A1
(43) Pub. Date: Nov. 19, 2020

(54) FRAME ASSEMBLY WITH CARD SLIPS AND COMBINATIONS THEREOF

(71) Applicant: Edgardo Clores, Las Vegas, NV (US)

(72) Inventor: Edgardo Clores, Las Vegas, NV (US)

(21) Appl. No.: 15/912,829

(22) Filed: Mar. 6, 2018

(51) Int. Cl. A47G 1/16; B42D 15/02; A47G 1/06

(52) U.S. Cl. CPC A47G 1/1606; A47G 2001/0688; A47G 1/06; B42D 15/02

(57) ABSTRACT

The present disclosure relates to a frame assembly. More particularly, this disclosure describes a frame assembly having a frame with a slot for inserting and removing holiday card slips. In one illustrative embodiment, the frame may include a front surface and a back surface separated by a plurality of sides forming an interior portion for securing a card slip. The frame may include a slot between the front surface and the back surface for receiving and removing the card slip. The frame assembly may include a plurality of card slips representing holidays through the year. Double-sided card slips maybe used.

### TECHNICAL FIELD

This disclosure generally relates to a frame, and more particularly, to a frame assembly having a predefined set of double-sided card slips that may be easily inserted into and taken out of the frame based on events throughout the year.

### BACKGROUND

Throughout the year, people may adorn rooms within their homes and places of business with various decorations. Some of these decorations may include pictures or paintings mounted to a wall. They may be captured by photographers through the use of a camera or painted by an artist. Different seasons may be captured through these pictures or paintings. For example, during the winter season, trees having no leaves and covered with snow may be depicted. This may convert an “ordinary” room into one having a decor that evokes the “winter spirit”.

A frame may surround the picture or painting to provide a decorative edging. Also, the frame may be used to mount the picture or painting to the wall. The frame may protect the picture or painting within. Typical constructions of the frame may include a front structure and a backing mounted to the front structure to retain the picture or painting. The backing is typically a heavy cardboard. The backing may commonly include wall mounts such as a paper tab, hole, bracket, or wire for mounting over a nail driven into the wall.

There may be drawbacks with current frames. Pictures or paintings within the frame may be hard to replace. The frame may be taken off the wall. The backing may be removed from the front structure and the picture or painting is taken out. A new picture or painting may be placed into the front structure and the backing is placed back thereon. Often times, this process may lead to the picture or painting staying up on the wall for years as the processes of removing it may take too much effort. Furthermore, mounts for the wall mounts on the backing may be loosened each time the frame is taken off the wall which may eventually lead to the wall mounts damaging the wall.

The present disclosure provides a frame with card slips and combinations thereof that solves each of the described concerns. The frame may allow easy insertion and removal of the card slips without damaging them. Furthermore, damage to the wall may be minimized, or eliminated, by allowing the frame to stay on the wall during insertion and removal of the card slips. Other benefits and advantages will become clear from the disclosure provided herein and those advantages provided above are for illustration.

### SUMMARY

This summary is provided to introduce a selection of concepts in a simplified form that are further described below in the DESCRIPTION OF THE DISLCOSURE. This summary is not intended to identify key features of the claimed subject mailer, nor is it intended to be used as an aid in determining the scope of the claimed subject matter.

In accordance with one aspect of the present disclosure, a frame is provided. The frame may include a front surface and a back surface. In addition, the frame may include a plurality of sides between the front surface and back surface for securing a card slip. The frame may also include a slot between the front surface and back surface for receiving or removing the card slip.

In accordance with another aspect of the present disclosure, a frame assembly is provided. The frame assembly may include a card slip. In addition, the frame assembly may include a frame having a front surface and a back surface separated by a plurality of sides forming an interior portion for securing the card slip and a slot between the front surface and the back surface for receiving and removing the card slip.

In accordance with yet another aspect of the present disclosure, a frame assembly is provided. The frame assembly may include a frame having an interior portion formed by a front surface and back surface separated by a plurality of sides and a slot. In addition, the frame assembly may include a card slip having an image inserted to and removed from the interior portion of the frame through the slot.

### BRIEF DESCRIPTION OF DRAWINGS

The novel features believed to be characteristic of the disclosure arc set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a top perspective view of an exemplary frame assembly with a card slip in accordance with one aspect of the present disclosure;

FIG. 2 is a view of illustrative card slips that may be placed or removed from an exemplary frame in accordance with one aspect of the present disclosure;

FIG. 3 is a view of an illustrative card slip that may be inserted or extracted from the exemplary frame in accordance with one aspect of the present disclosure;

FIG. 4 is a top perspective view of the exemplary frame for holding the illustrative card slip in accordance with one aspect of the present disclosure;

FIG. 5 is a side perspective view of the exemplary frame in accordance with one aspect of the present disclosure; and

FIG. 6 is a back perspective view of the exemplary frame in accordance with one aspect of the present disclosure.

### DESCRIPTION OF THE DISCLOSURE

The foregoing description is provided to enable any person skilled in the relevant art to practice the various embodiments described herein. Various modifications to these embodiments will be readily apparent to these skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that arc known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

The present disclosure relates to a frame assembly. More particularly, this disclosure describes a frame assembly having a frame with a slot for insetting and removing holiday card slips. In one illustrative embodiment, the frame may include a front surface and a back surface separated by a plurality of sides forming an interior portion for securing a card slip. The frame may include a slot between the front surface and the back surface for receiving and removing the card slip. The frame assembly may include a plurality of card slips representing holidays through the year. Double-sided card slips may be used.

Numerous other modifications or configurations to the frame assembly will become apparent from the description provided below. For example, different shapes, patterns, colors and aesthetics may be used tor the frame. Advantageously, the frame of the frame assembly may properly secure the card slips. Furthermore, extracting these card slips may remove the need from taking the frame off the wall thus reducing, or removing completely, damage to it. Other advantages will become apparent from the description provided below.

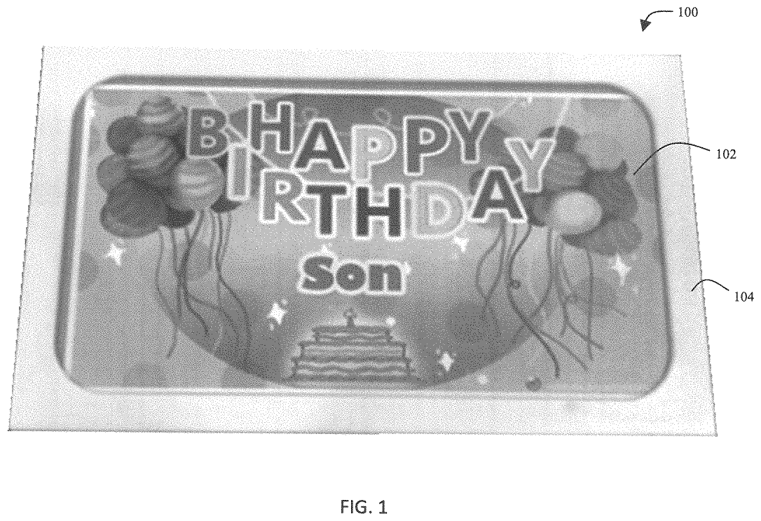

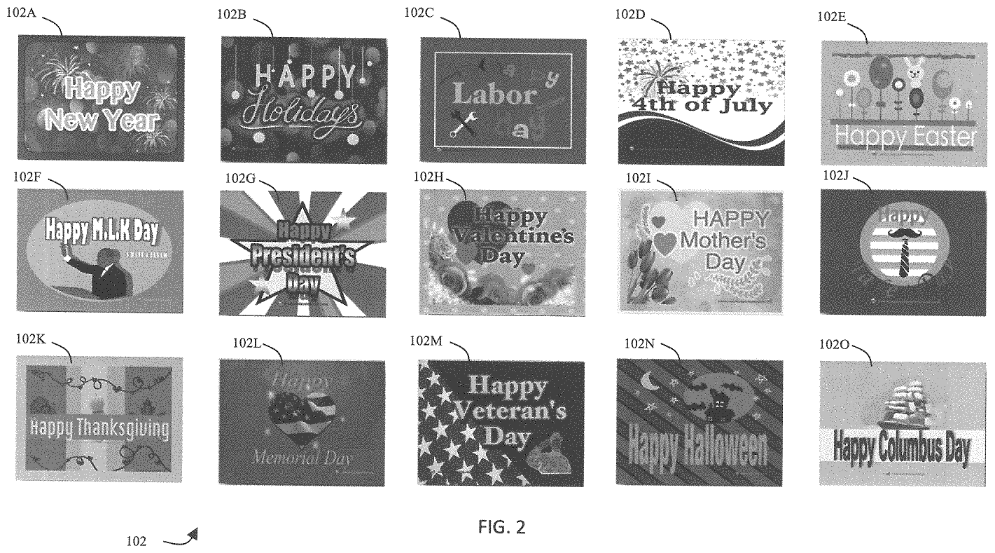

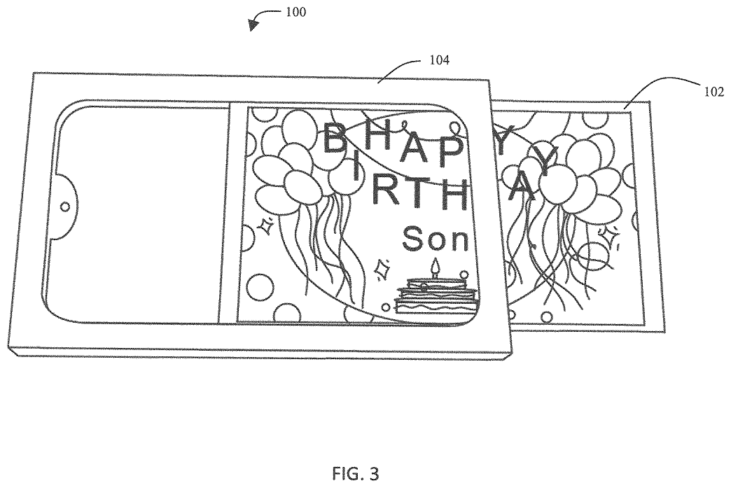

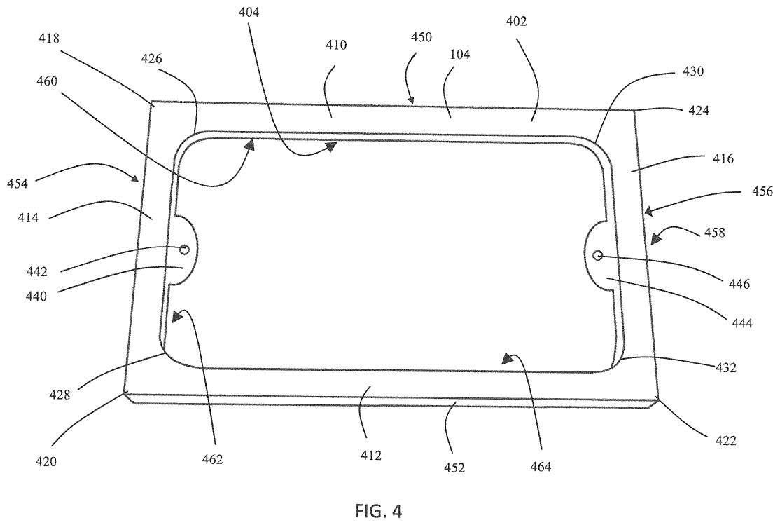

The present disclosure will depict the frame assembly in FIG. 1. FIG. 2 shows the plurality of card slips while FIG. 3 shows an insertion or extraction of the card slip into or from the frame. FIGS. 4 through 6 describe features of the frame from different viewing perspectives.

Turning to FIG. 1, a top perspective view of an exemplary frame assembly 100 with a card slip 102 in accordance with one aspect of the present disclosure is provided. The frame assembly 100 may include a frame 104 and a plurality of associated card slips 102. The shown frame 104 and card slip 102 is for purposes of illustration and should not be construed as limiting to the present disclosure. The card slips 102 may be made specific to the frame 104. That is the dimensions as well as the aesthetics of the card slips 102 may be created in view of the frame 104.

The frame 104, of the frame assembly 100, may be made of wood. Other materials that may be used to make the frame 104 may include, but is not limited to, silver, bronze, aluminum and plastic. A variety of colors may be used for the frame 104. A color that is aesthetically pleasing with the card slip 102 may be chosen, for example, white may be a color that fits in with events through the year.

In addition to the different materials and colors, the frame 104 may be constructed with different shapes. That is, the frame 104 may come in a rectangle as shown, or in the alternative, a square. In one embodiment, the shape of the frame 104 may be greater in height than the width. Circular or oval shapes may be used to construct the frame 104. The card slip 102 may be shaped accordingly.

Different patterns or textures on the frame 104 may be used. For example, a border on the outside of the frame 104 may be provided. The border may enhance the card slip 102. Hexagonal, cross-hatched, parallel lines or the like may be used to define patterns on the frame 104. Different textures may also be part of the frame 104.

Now turning to the card slip 102, it may come in a variety of forms and depict different images. In one embodiment, these images may represent holidays throughout the year. Other occasions such as birthdays, anniversaries or the like may be placed thereon. FIG. 2 is a view of illustrative card slips 102 that may be placed in or removed from the exemplary frame 104 in accordance with one aspect of the present disclosure. While the card slips 102 are shown as single sided, they may come as doubled-sided.

The following is a representative of illustrative card slips 102:
Card slip 102A: Happy New Years;
Card slip 102B: Happy Holidays;
Card slip 102C: Happy Labor Day;
Card slip 102D: Happy 4^{th} of July;
Card slip 102E: Happy Easter;
Card slip 102F: Martin Luther King;
Card slip 102G: Happy President's Day;
Card slip 102H: Happy Valentine's Day;
Card slip 102I: Happy Father's Day,
Card slip 102K: Happy Thanksgiving;
Card slip 102L: Happy Memorial Day.
Card slip 102M: Happy Veteran's Day;
Card slip 102N: Happy Halloween; and
Card slip 102A: Happy Columbus Day.

In one embodiment, images depending on the time of the year may be placed together on the double-sided card slip 102. That is, holidays that arc near each other may be represented on the same card slip 102 on opposite sides. Advantageously, and by placing images of events that are near one another on the same card slip 102, the card slip 102 may not have to be exchanged for a new card slip 102. The same card slip 102 may be used by turning it around.

While numerous cards slips 102 have been shown, they should not be construed as limiting. For example, card slips 102 that were not shown may include special occasions such as anniversaries, birthdays or the like. In one embodiment, the card slips 102 may also be personalized such that specific names may be provided within the images. For example, a special birthday card slip 102 may state specific names such as “Happy Birthday John” or “Happy Anniversary Jane”. Typically, on a first order of the frame assembly 100, ten double-sided card slips 102 may be provided. These may represent sixteen major United States holidays along with other occasions. The card slips 102 may also come in different languages and may be associated with various holidays for other countries.

FIG. 3 is a view of an illustrative card slip 102 that may be inserted or extracted from the exemplary frame 104 in accordance with one aspect of the present disclosure. As defined herein, the frame assembly 100 may incorporate the frame 104 and the card slip 102. The card slip 102, as shown, may be inserted to the frame 104. Alternatively, the card slip 102 may be extracted from the frame 104. In operation, a user may simply push the card slip 102 from a middle portion in or out of the frame 104.

Referring to FIG. 4, a top perspective view of the exemplary frame 104 for holding the illustrative card slip 102 in accordance with one aspect of the present disclosure is provided. The frame 104 may include a front surface 402 and a back surface 404 separated or fused together by a top side 450, bottom side 452, left side 454 and right side 456. The combination of these components may form an interior compartment for the card slip 102. Fewer or more components may be part of the frame 104 and may be described using different terminologies set forth below.

The front surface 402 of the frame 104 may include a top portion 410, bottom portion 412, left portion 414 and right portion 416. The top portion 410 and bottom portion 412 may be parallel to one another while the left portion 414 and right portion 416 may be parallel to one another. The left portion 414 and the right portion 416 of the frame 104 may be perpendicular to the top portion 410 and bottom portion 412.

At the intersection of the top portion 410 and left portion 414, a corner 418 may be formed on the exterior edge of the frame 104. This corner 418 may also be part of the top side 450 and left side 454. On the interior of the intersection, a curved interior edge 426 may be made. A corner 420 may also be formed between the intersection of the left portion 414 and the bottom portion 412. This corner 420 may be part of the left side 454 and the bottom side 452. Similarly, a curved interior edge 428 may be made on the interior of this intersection.

As further shown in FIG. 4, a corner 422 may be formed between the intersection of the bottom portion 412 and the right portion 416 of the front surface 402 of the frame 104. A curved interior edge 432 may be created on the interior of this intersection. A corner 424 may also be formed between the intersection of the right portion 416 and the top portion 410. A curved interior edge 430 may be made on the interior of this intersection.

The front surface 402 may have an opening. The opening may provide a view of the card slip 102 that may be inserted into the frame 104. The curved edges 426, 428, 430, and 432 may create an opening that adds a flare to the card slip 102 that is inserted therein. Through the curved edges 426, 428, 430, and 432, the opening within the front surface 402 may have rounded corners. The front surface 402 may incorporate other types of shapes for the curved interior edges 426, 428, 430, and 432 and it does not necessarily have to be curved. These can be squared or any other shape.

The back surface 404, which will be described in more details below, may be similar to the front surface 402. On the back surface 404 may be at least one wall mount. For purposes of illustration, the back surface may include two wall mounts, that is, a left wall mount 440 and a right wall mount 444. A left aperture 442 may be part of the left wall mount 440 and a right aperture 446 may be provided on the right wall mount 444. For both wall mounts 440 and 444, a fastener may be driven through the apertures 442 and 446, for example, a nail or screw. The fastener may be secured into the dry wall such that the frame 104 may be securely held. Other types of fasteners may be used such as hooks and loop type fasteners, clasps, buckles, zippers, snaps, buttons, magnets, screws, nuts and bolts, adhesives, releasable adhesives or the like to secure the frame 104 to the wall.

As described before, the frame 104 may include a top side 450, bottom side 452, left side 454 and right side 456. The top side 450, bottom side 452 and left side 454 may create a perimeter. With the perimeter fused to the front surface 402 and back surface 404, the interior portion may be formed for fitting the card slip 102. On the right side 456, an insertion slot 458 may be provided. This slot 458 may allow the card slip 102 to be placed therein or removed therefrom by sliding the card slip 102 in and out. In one embodiment, this slot 458 may be formed on the left side 454 with the right side 456 being solid and not having the slot 458. In another embodiment, both the left side 454 and the right side 456 may have slots 458 such that the card slip 102 may be inserted or removed from either side 454 or 456.

A number of recesses 460, 462 and 464 may also be formed by the perimeter with the front surface 402 and the back surface 404. That is, indentations may be made through the combination of these components. These recesses 460, 462 and 464 may be able to hold the card slip 102 into place. For example, a top recess 460 may be formed by the top side 450 with the front surface 402 and back surface 404. This recess 460 may hold a top portion of the card slip 102.

The side recess 462 of the frame 104 may be formed by the left side 454 with the front surface 402 and the back surface 404. This recess 462 may prevent the card slip 102 from sliding out of the frame 104. In one embodiment, the side recess 462 may lock the card slip 102 into place once it has been inserted into the frame 104. The recess 462 may form a narrowing channel, that is, as the card slip 102 is pushed towards the left side 454 the narrower the width of the recess 462 may get. This narrow channel may begin to secure the card slip 102 as it is pushed towards the narrowing channel finally locking the slip 102 into place.

The bottom recess 464 may be formed by the bottom side 452 with the front surface 402 and the back surface 404. This recess 464 may be used to secure the card slip 102 from falling out of the frame 104. In one embodiment, each of the recesses 460 and 464 may have a similar narrowing channel to that of the recess 462 formed on the left side 454 such that the card slip 102 may be secured within those recesses 460 and 464. Other mechanisms may also be used to secure the card slip 102 into place within the frame 104. For example, grooves or ridges may be used within each of the recesses 460, 462 and 464.

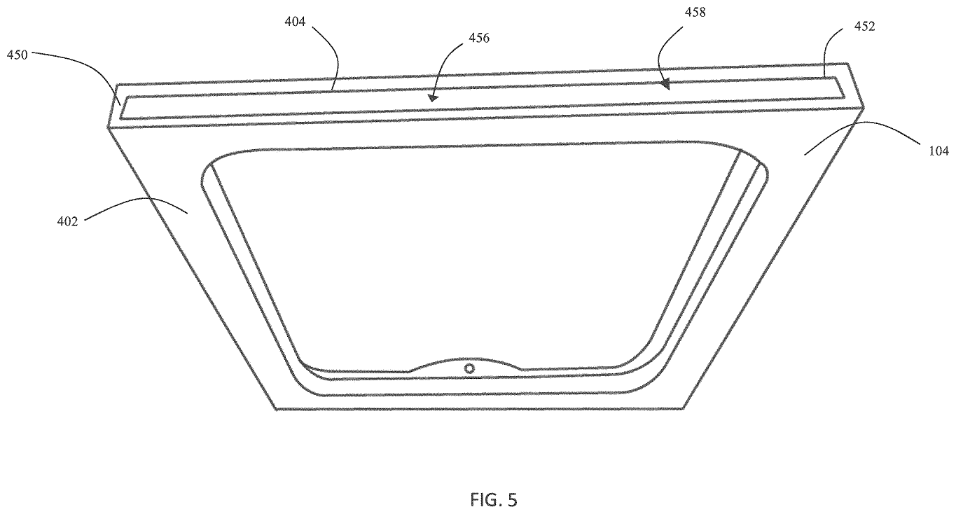

FIG. 5 is a side perspective view of the exemplary frame 104 in accordance with one aspect of the present disclosure. The card slip 102 may be inserted or removed from the insertion slot 458. The slot 458 may be formed through the right side 456 of the frame 104. In one alternative embodiment, and as described above, the left side 454 of the frame 104 may include the slot 458.

The slot 458 may be formed on the right side 456 from a number of different components of the frame 104. That is, the back surface 404, top side 450, front surface 402 and bottom side 452 may be used to delineate the right side 456 with the insertion slot 458 there through. The insertion slot 458 may take on similar, or the same, dimensions as the card slips 102 that are inserted and removed from the slot 458. That is, the height and width of the card slip 102 may be similar, or the same, to the dimensions of the insertion slot 458. Furthermore, the length of the card slip 102 may be similar, or the same, to a length of the top side 450 and bottom side 452 of the frame 104.

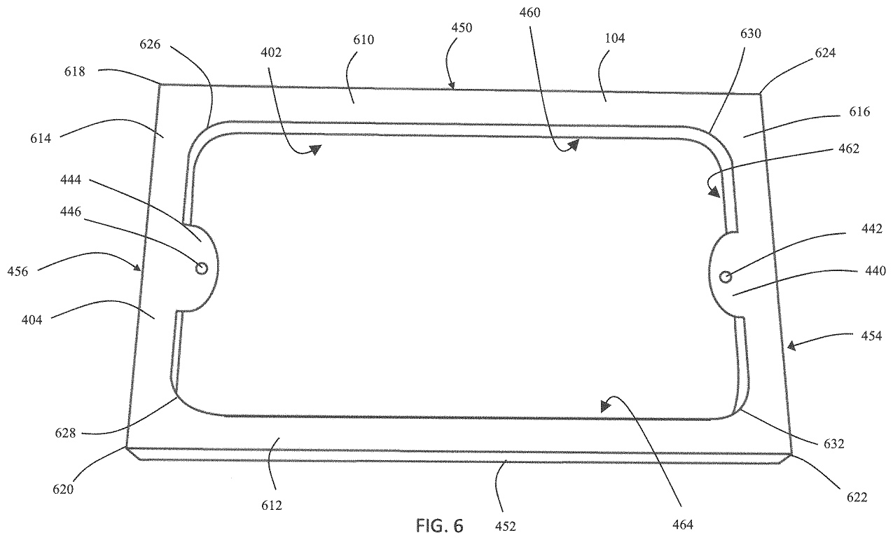

FIG. 6 is a back perspective view of the exemplary frame 104 in accordance with one aspect of the present disclosure. The back surface 404 may have similar, or the same, components of the front surface 402. The back surface 404 may include a top portion 610, bottom portion 612, a left portion 614 and right portion 616. The top portion 610 and bottom portion 612 may be parallel to one another while the left portion 614 and right portion 616 may be parallel to one another. The left portion 614 and the right portion 616 may be perpendicular to the top portion 610 and bottom portion 612.

At the intersection of the top portion 610 and left portion 614, a corner 618 may be formed on the exterior edge of the frame 104. This corner 618 may also be part of the top side 450 and right side 456. On the interior of the intersection, a curved interior edge 626 may be made. A corner 620 may also be formed between the intersection of the left portion 614 and the bottom portion 612. This corner 620 may be part of the right side 456 and the bottom side 452. Similarly, a curved interior edge 628 may be made on the interior of this intersection.

A corner 622 may be formed between the intersection of the bottom portion 612 and the right portion 616 of the back surface 404 of the frame 104. A curved interior edge 632 may be created on the interior of this intersection. A corner 624 may also be formed between the intersection of the right portion 616 and the top portion 610. A curved interior edge 630 may be made on the interior of this intersection.

The back surface 404 may have an opening similar to the front surface 402. The curved interior edges 426, 428, 430 and 432 of the front surface 402 may match the curved edges 626, 628, 630 and 632 of the back surface 404. In one embodiment, the back surface 404 may be solid. That is, a solid configuration with no opening may be used for the back surface 404. Typically, the back surface 404 is not shown once the card slip 102 has been placed in the frame 104 thus removing benefits of having features similar to the front surface 402. The wall mounts 440 and 444 with apertures 442 and 446 may be changed to a single mount if the back surface 404 is solid. Other combinations of mounts may exist and should not be limited to those shown.

As described above, the top recess 460, side recess 462 and bottom recess 464 were formed from the perimeter with the front surface 402 and the back surface 404. With more specific details, the top recess 460 may be formed by the top portion 610 of the back surface 404 and the top portion 610 of the front surface 402 with the top side 450. The side recess 462 may be formed by the right portion 616 of the back surface 404 and the left portion 414 of the front surface 402 with the left side 454. The bottom recess 464 may be formed by the bottom portion 612 of the back surface 404 and the bottom portion 412 of the front surface 402 with the bottom side 452.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A frame comprising:
a front surface and a back surface:
a plurality of sides between the front surface and back surface;
a slot between the front surface and back surface;
a plurality of pre-printed card slips stored within the slot, the plurality of sides securing the plurality of pre-printed card slips within the slot; and
wherein the slot is formed on one side of the frame for inserting and removing the plurality of pre-printed card slips to change which of the plurality of pre-printed card slips is being displayed based on a time of year.

2. The frame of claim 1, wherein the plurality of sides comprise a top side, bottom side and vertical side, the slot formed opposite the vertical side.

3. The frame of claim 2, wherein the top side, bottom side and vertical side form a perimeter preventing the plurality of pre-printed card slips from falling out of the frame.

4. The frame of claim 1, wherein the plurality of pre-printed card slips each displays a different holiday.

5. The frame of claim 2, wherein the top side, bottom side and vertical side form a recess between the front surface and back surface.

6. The frame of claim 1, wherein the front surface comprises an opening having rounded corners.

7. The frame of claim 1, wherein the back surface comprises an opening having rounded corners

8. The frame of claim 1, wherein the back surface comprises a solid surface.

9. A frame assembly comprising:
a plurality of pre-printed card slips, wherein each of the plurality of pre-printed card slips displays a different holiday; and
a frame having a front surface and a back surface separated by a plurality of sides forming an interior portion for securing the plurality of pre-printed card slips and a slot between the front surface and the back surface for receiving and removing the plurality of pre-printed card slips to change which one of the plurality of pre-printed card slips is to be displayed based on a time of year.

10. The frame assembly of claim 9, wherein the plurality of sides comprise a top side, bottom side and vertical side with the slot opposite the vertical side.

11. The frame assembly of claim 10, wherein the top side, bottom side and vertical side each form a recess between the front surface and back surface.

12. The frame assembly of claim 9, wherein each of the plurality of pre-printed card slips is double sided and displays different holiday image.

13. (canceled)

14. The frame assembly of claim 9, wherein the back surface comprises at least one wall mount.

15. The frame assembly for the plurality of card slips of claim 14, wherein the at least one wall mount comprises an aperture.

16. A frame assembly comprising:
a frame having an interior portion formed by a front surface and back surface separated by a plurality of sides and a slot; and
a plurality of pre-printed card slips stored in the interior portion of the frame, wherein each of the plurality of pre-printed card slips have a different holiday image, the plurality of pre-printed card slips being inserted and removed from the interior portion of the frame through the slot to change which holiday image is being displayed.

17. (canceled)

18. The frame assembly of claim 16, wherein the plurality of pre-printed card slips are double sided depicting different holiday images on each side.

19. The frame assembly of claim 16, wherein the front surface and back surface are rectangular.

20. The frame assembly of claim 16, wherein the front surface and back surface are shaped as a square.
